(19) United States
(12) Patent Application Publication
(10) Pub. No.: US 2014/0295069 A1
(43) Pub. Date: Oct. 2, 2014

(54) Nanostructured High Voltage Cathode Materials

(71) Applicants: Zhigang Lin, Irvine, CA (US); Chunhu Tan, Irvine, CA (US)

(72) Inventors: Zhigang Lin, Irvine, CA (US); Chunhu Tan, Irvine, CA (US)

(73) Assignee: Aegis Technology Inc., Santa Ana, CA (US)

(21) Appl. No.: 14/275,895

(22) Filed: May 13, 2014

Related U.S. Application Data
(62) Division of application No. 12/879,423, filed on Sep. 10, 2010.

(51) Int. Cl. C01B 31/02; C01B 25/45

(52) U.S. Cl. CPC C01B 31/02; C01B 25/45
USPC 427/122

(57) ABSTRACT

Objects of the present invention include creating cathode materials that have high energy density and are cost-effective, environmentally benign, and are able to be charged and discharged at high rates for a large number of cycles over a period of years. One embodiment is a battery material comprised of a doped nanocomposite. The doped nanocomposite may be comprised of Li—Co—PO4; C; and at least one X, where said X is a metal for substituting or doping into LiCoPO4. In certain embodiments, the doped nanocomposite may be LiCoMnPO4/C. Another embodiment of the present invention is a method of creating a battery material comprising the steps of high energy ball milling particles to create complex particles, and sintering said complex particles to create a nanocomposite. The high energy ball milling may dope and composite the particles to create the complex particles.

### REFERENCE TO RELATED APPLICATIONS

This application is a divisional of U.S. application Ser. No. 12/879,423 that was filed on Sep. 10, 2010.

### STATEMENT REGARDING FEDERALLY SPONSORED RESEARCH OR DEVELOPMENT

Certain work described herein was supported by SBIR grant no. DE-SC0000941. The Government may have certain rights in this invention.

### BACKGROUND OF THE INVENTION

(1) Field of the Invention

The field of the invention relates to cathode materials.

(2) Description of Related Art Including Information Disclosed Under 37 CFR 1.97 and 1.98

There is great interest in developing rechargeable Li-ion batteries with higher energy density, or specific capacity, for both military and commercial applications. For instance, if a high-performance Li-ion battery can be employed instead of conventionally used nickel metal hydride (NiMH) batteries, significant advantages in power densities, capacities and energy efficiency can be achieved. In a vehicle, this would translate to better mileage due to lower vehicle weight, better storage space due to smaller battery packs, and increased performance due to better power characteristics. To achieve these potential benefits of Li-ion batteries, more demanding requirements are needed on the performance enhancement of state-of-the-art Li-ion batteries including higher energy density and better stability. Development of more advanced positive electrodes (cathodes) for Li-ion batteries is one of the essential key technologies to realize these requirements. Currently, up to 40-41% of Li-ion battery mass is dominated by the cathode, and therefore high specific energy is critically important to the achievement of lightweight, compact structure. The availability of high-performance cathode materials will be of great benefit to significantly improve the performance of Li-ion batteries and enables the development of more advanced Li-ion systems for new-generation hybrid electric vehicles (HEV) and other applications.

Current cathode materials for Li-ion batteries in production today are dominated by lithium cobalt oxide (LiCoO2) and its derivatives. However, although this cathode material possesses low theoretical energy density, it also suffers from some limitations which obstruct their military/commercial applications in next-generation HEVs, among other applications. For example, at present only one half (˜135 mAh/g) of its theoretical capacity can be potentially achieved for the LiCoO2 cathode. Moreover, LiCoO2 does not have sufficient stability especially at elevated temperatures, and it is relatively expensive. Other similar metal oxides recently explored, including LiNiO2 and LiCoₓNi₁₋ₓO₂ derivatives and LiMn2O4, also have some disadvantages unattractive for HEV applications. For example, there is an issue of stability with overcharge for LiNiO2 and LiCoₓNi₁₋ₓO₂ derivatives, and an issue of capacity losses on cycling and performance degrading at elevated temperatures for LiMn2O4.

Additional information relevant to attempts to address these problems can be found in U.S. Pat. Nos. 6,544,690, 7,077,983, 7,217,386, 7,338,734, and 7,623,340, and U.S. Patent Publication Nos. 2003/0207976 and 2005/0191523. However, each one of these references at least suffers from disadvantages including one or more of the following: lower energy density, environmentally unfriendly, cumbersome manufacturing, cost ineffective, cycling degradation, performance degradation and narrow applicability.

All referenced patents, applications and literatures are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply. The invention may seek to satisfy one or more of the above-mentioned desires. Although the present invention may obviate one or more of the above-mentioned desires, it should be understood that sonic aspects of the invention might not necessarily obviate them.

### BRIEF SUMMARY OF THE INVENTION

Accordingly, an object of the present invention is for cathode materials that have high energy density and are cost-effective, environmentally benign, and is able to be charged and discharged at high rates for a large number of cycles over a period of many years.

One embodiment of the present invention is a battery material comprised of a doped nanocomposite. The doped nanocomposite may be comprised of Li—Co—PO4, C, and at least one X, where said X is a metal for substituting or doping into LiCoPO4. In certain embodiments, the doped nanocomposite may be LiCoMnPO4/C.

An embodiment of the present invention is a method of creating a battery material comprising the steps of high energy ball milling particles to create complex particles, and sintering said complex particles to create a nanocomposite. The high energy ball milling may dope and composite the particles to create the complex particles. In one embodiment, the particles are comprised of Li, Co, PO4, C and at least one metal. The metal may be selected from the group consisting of Fe, Mn, and Ni. In an embodiment, a said metal is selected as Mn. The nanocomposite is LiCoMnPO4/C in an embodiment.

Another embodiment of the present invention is an electrode for a battery comprised of a doped nanocomposite. The doped nanocomposite may be comprised of Li—Co—PO4, C, and at least one X, where said X is a metal for substituting or doping into LiMPO4. In certain embodiments, the doped nanocomposite is LiCoMnPO4/C.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates a flow chart for the three step material processing method embodiment of LCP/C nanocomposite.

FIG. 2 illustrates a flow chart for the one-step material processing method embodiment of LCP/C nanocomposite.

FIG. 3 illustrates XRD results for an embodiment of a LCP/C nanocomposite synthesized from cryomilled powders in the three step procedure.

FIG. 4 illustrates XRD results for an embodiment of a LCP/C nanocomposite synthesized with a single-step procedure.

FIG. 5 illustrates a SEM image for an embodiment with the LCP/C nanocomposites synthesized from cryomilled powders with 8 hours of milling time.

FIG. 6 illustrates a SEM images of one embodiment of LCP/C nanocomposite particles prepared using the one-step procedure at 650 C and 8 hours.

FIG. 7(a) illustrates charge-discharge curses in an embodiment of LCP/C nanocomposite before annealing.

FIG. 7(b) illustrates charge-discharge curves in an embodiment of LCP/C nanocomposite after annealing.

FIG. 8 illustrates charge-discharge curves in an embodiment of LCP/C nanocomposite prepared with the one-step procedure with 18 hours of sintering time.

FIG. 9 illustrates XRD results for an embodiment of doped LCP samples with 10 mol. % Mn and 10 mol. % Ni.

FIG. 10 illustrates Charge-discharge curves of an embodiment of 10 mol % Mn and 10 mol % Ni doped LCP (LiCo0.9Mn0.1PO4 and LiCo0.9Ni0.1PO4) at first charge-discharge cycles at 0.1 C.

FIG. 11 illustrates XRD results for an embodiment of synthesized LFP and doped samples with Mn and Ni elements.

FIG. 12(a) illustrates charge-discharge results for an embodiment of a pure LFP (LiFePO4).

FIG. 12(b) illustrates charge-discharge results for an embodiment of doped LFP, LFMP (LiFe0.9MN0.1PO4).

FIG. 12(c) illustrates charge-discharge results for an embodiment of doped LFP, LFNP (LiFe0.9Ni0.1PO4).

FIG. 13 illustrates a typical structure of a cylindrical Li-ion cell.

FIG. 14 illustrates as flow chart of an example of an assembly procedure of a Li-ion cell.

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

### Definitions

A “doped nanocomposite” is a nanocomposite that has been doped with either a same or as different material or elements as the nanocomposite. A “complex particle” is as particle which is combination of various materials or elements but is not a complete coalesced mix of all the component materials or elements.

### Material Processing

There are many possibilities for material processing embodiments of LCP/C nanocomposites. Among many embodiments are two preferred embodiments for processing approaches to prepare the nanocomposites.

One embodiment is a processing approach as a three-step procedure. These steps consists of (1) solid-state reaction (SSR), (2) cryomilling (High energy ball milling in a liquid nitrogen media), and (3) carbon-coating.

Another embodiment is a single-step processing, similar with the SSR, which is aimed to synthesize the LCP/C nanocomposite as a single step procedure and thus reduce the total processing time and cost. Additional embodiments may process the substitute-doping LCP samples by partially (1-10 mol %) replacing Co with Mn, Ni or Fe.

LCP/C Nanocomposite Processing through the Three-Step Procedure

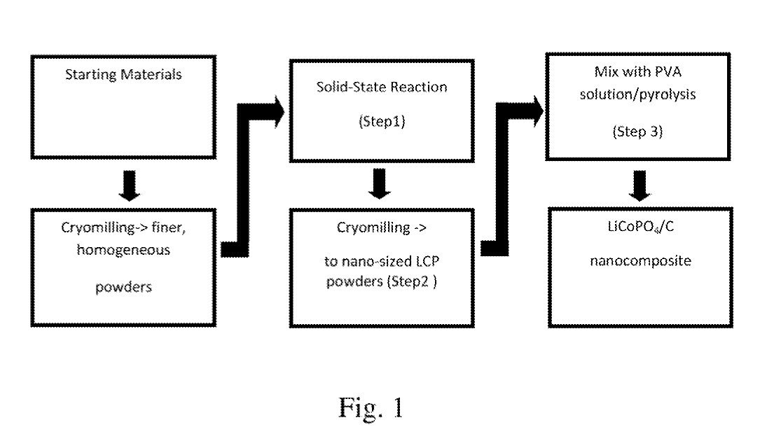

In the three-step processing embodiment, the first step is for LCP fresh powder to be first synthesized by using a solid-state reaction (SSR). The second step is for the LCP fresh powders synthesized to be then cryomilled into nano-size particles. The third step is for the cryomilled powders to mix with poly(vinyl alcohol) (PVA) aqueous solution and undergo heat treatment (pyrolysis of PVA) to produce the carbon coating onto the particles. A flow chart describing this procedure is shown in FIG. 1. Each step will be discussed in more detail below.

Step 1: Material Synthesis with SSR

In embodiments for this step, pure-phase LCP fresh powder is synthesized using a solid state reaction (SSR) method. LCP powder synthesis is a key step in material processing. In preferred embodiments, the starting materials include Li₂CO₃, CoO, and P₂O₅. Prior to solid-state reaction, these materials are first cryomilled (high energy ball milling in a liquid nitrogen media) for 8 hours in order to obtain a homogenous and fine mixture. Once the cryomilling is completed and the left liquid nitrogen (LN2) was completely evaporated, the mixture is then fired in a tube furnace under an argon gas environment. Various different temperatures and times may be used to provide various optimizations and for optimized parameters for the synthesis of the fully pure phase LCP without the generation of other phases and overgrowth of the synthesized particles. The as-prepared fresh powders may be subjected to characterizations via X-ray diffraction (XRD) and Scanning Electron Microscope (SEM) that are used to select the best processing parameters. In a more preferred embodiments, fresh powder samples may be synthesized at 750° C. for 36 hours.

### Step 2: Nanomaterial Processing by Cryomilling

In embodiments for this step, the LCP fresh powders synthesized above are further processed to achieve a finer particle size (ideally down to nano sizes) by using a high-energy ball milling under liquid nitrogen (LN2), which is also referred to as cryomilling. In this step, different milling times may be used for different preferred embodiments. The cryomilling time is the most critically influential parameters for the achievement of nanoparticle size. In certain preferred embodiments, the fresh powder may be milled for 8 hours, 12 hours, 18 hours, or 24 hours in order to vary the influence of milling time on the microstructure and morphology of the resultant powder. In a more preferred embodiment, an eight (8) hour cryomilled powder sample may be used to perform carbon-coating processing.

### Step 3: Carbon-Coating

In embodiments for this step, the cryomilled LCP powders processed in Step 2 are then carbon-coated to obtain a LCP/C nanocomposite. In a more preferred embodiment, a PVA aqueous solution is used as the carbon source. Typically, 4 wt. % carbon-coating is used for commercial LiFePO₄ powder. Therefore, a similar percentage is used in synthesizing a nanocomposite. In the course of processing, a 10% aqueous PVA solution is first made (PVA powders needed to be fully dissolved). The LCP powders are then mixed into the PVA solution. The amount of solution needs to provide a yield ratio of PVA at ˜4%. The resultant mixture of LCP/PVA is milled using high energy milling for 2 hours. The resultant slurry is then dried to evaporate the water and to coat the PVA membrane upon the LCP powders. The fully dried powders are then fired in a tube furnace at 600° C. for 2 hours with an argon gas flow to transform the PVA into carbon. After cooling to room temperature, the carbon-coated LCP nanopowders, i.e., LCP/C nanocomposites, are obtained.

LCP/C Nanocomposite Processing through the One-Step Procedure

In embodiments for the one-step procedure for synthesizing LCP/C nanocomposites, synthesis is performed directly in a single step of solid state reaction (SSR). This one-step processing potentially is a low-cost process that however can also achieve the same results as that with the three-step procedure. In this process, material synthesis, nanoparticle preparation and carbon-coating are all accomplished in a single SSR step. This allows for more cost-effective processing for the LCP/C nanocomposite.

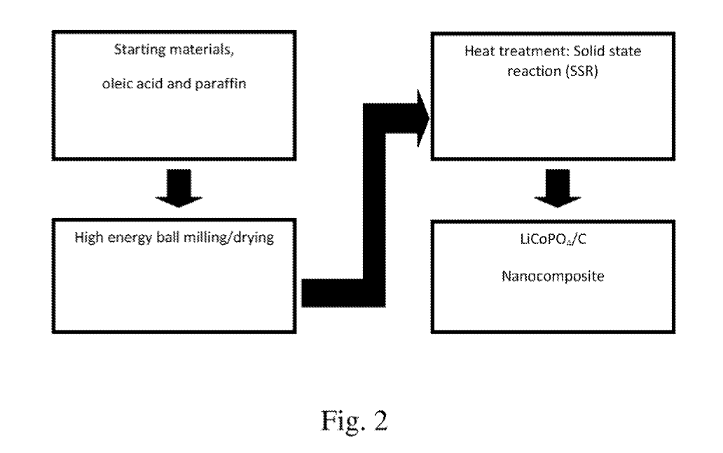

In preferred embodiments, the same starting materials (Li₂CO₃, CoO, and P₂O₅) are first mixed with oleic acid and paraffin wax by high energy ball milling for 2 hours at room temperature. The oleic acid is added as surfactant and paraffin was used as carbon source. After drying in an oven at 110° C. for 30 minutes, the precursor is fired in a tube furnace at 650° C. for 8 hours under an argon gas flow. A flow-chart of this procedure is shown in FIG. 2.

### Microstructure Analysis

Advantages and features of embodiments will become more apparent upon a following discussion of microstructure analysis.

### X-Ray Diffraction (XRD) Analysis

X-ray diffraction (XRD) is may be used to determine whether pure phase phospho-olivine structures have been synthesized successfully. In addition, XRD is used to identify the influence of the processing procedures on the crystal structure of the samples. XRD data was collected using the X Philips X'Pert automatic diffractometer. The machine was set for “Cu Ka radiation” operating at 40 kV and 40 mV. The measurement range of the scan was from 10° to 80°, a step size of 0.02°, and a counting time of 1.5 seconds.

LCP/C Nanocomposite Synthesized from Cryomilled Powders in the Three Step Procedure

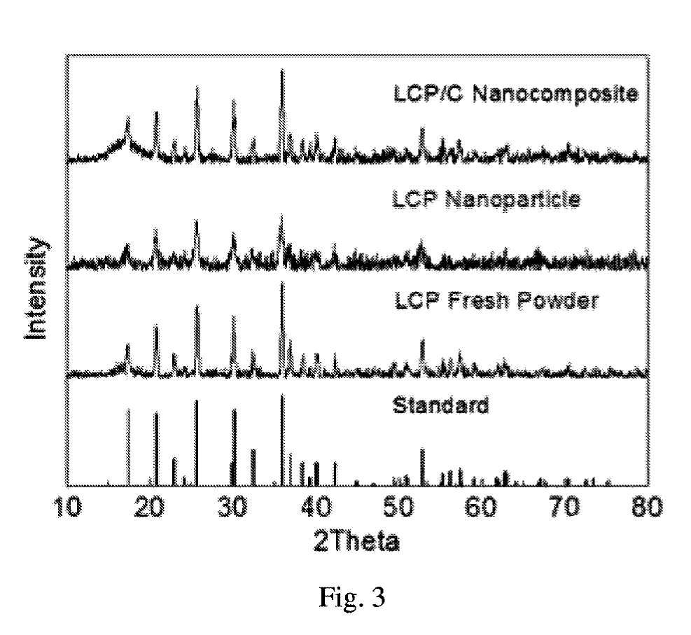

The XRD patterns of an embodiment with LCP/C nanocomposite synthesized are shown in FIG. 3. Here, the LCP/C nanocomposite is processed with the carbon coating onto the cryomilled LCP particles. It can be seen from FIG. 3 that the XRD patterns are similar with those of LCP fresh powders, and the peaks disappeared in cryomilled powders (LCP nanoparticle) were resumed. This should be attributed to the carbon-coating processing itself which also acts like an annealing process. It is also found that there is no carbon peak and other new peaks except for LCP, which suggest that the carbon coating might be in the form of amorphous structure.

LCP/C Nanocomposite Synthesized with a Single-Step Procedure

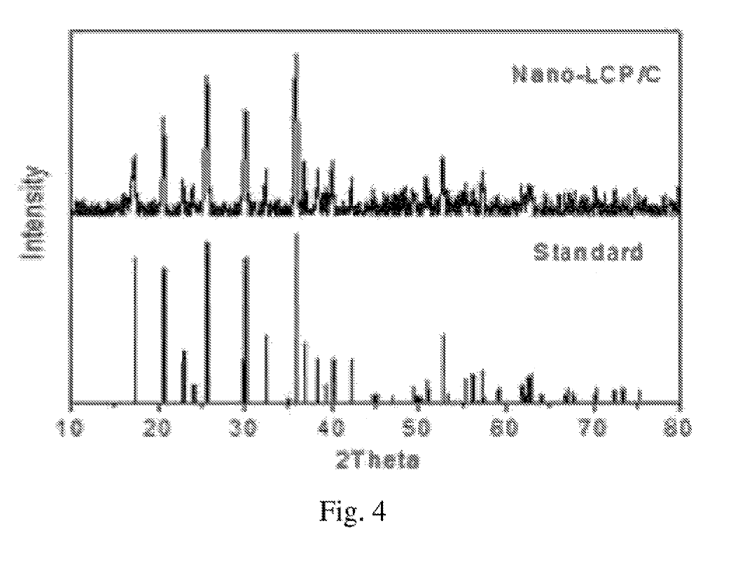

The XRD patterns of an embodiment using the single step procedure are illustrated in FIG. 4. Here, the one-step procedure, is used to synthesize LCP/C nanocomposites. From FIG. 4, it is clear that the method obtains pure phase LCPs. There is no other phase, including crystalline carbon (C) phase. The carbon should be in the form of an amorphous structure. Here, it can be clearly seen that an embodiment of the single-step processing also produces LCP/C nanocomposites.

### Scanning Electron Microscopy (SEM)

Microstructure (size and morphology) of the materials may be analyzed using scanning electron microscopy (SEM) and energy dispersive X-Ray spectroscopy (EDS). A Philips XL 30 machine equipped with an EDS analyzer may be used. The particle size and its morphology of cathode material play an important role in its electrochemical properties. Therefore, in order to obtain more intuitive knowledge about the materials in these aspects, the powder samples processed may be analyzed using SEM.

LCP/C Nanocomposites from Cryomilled LCP (3-Step Procedures)

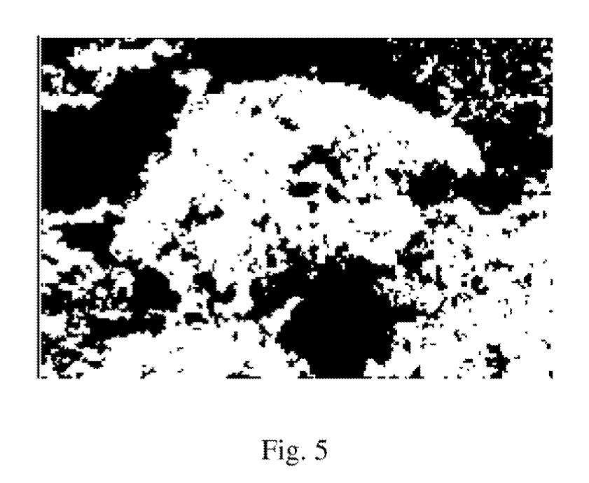

FIG. 5 shows the SEM images for an embodiment with the LCP/C nanocomposites synthesized from cryomilled powders with 8 hrs of milling time. The LCP/C nanocomposite should be of good quality due to the increase in electron conductivity of the composite particle.

LCP/C Nanocomposite Synthesized with One-Step Procedure

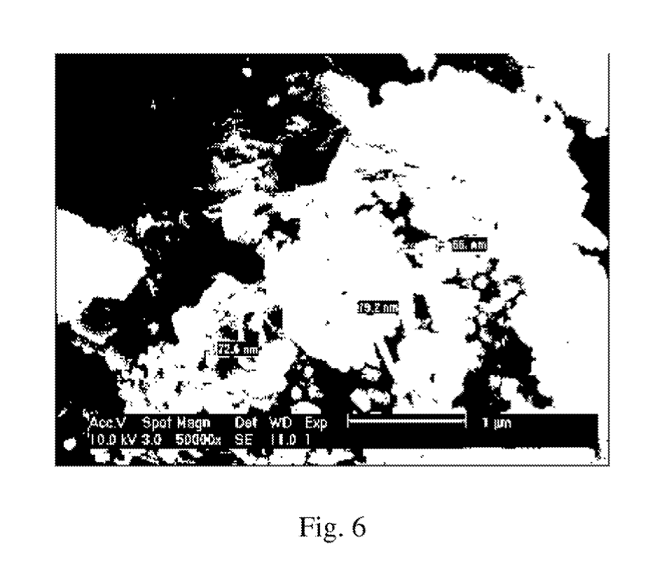

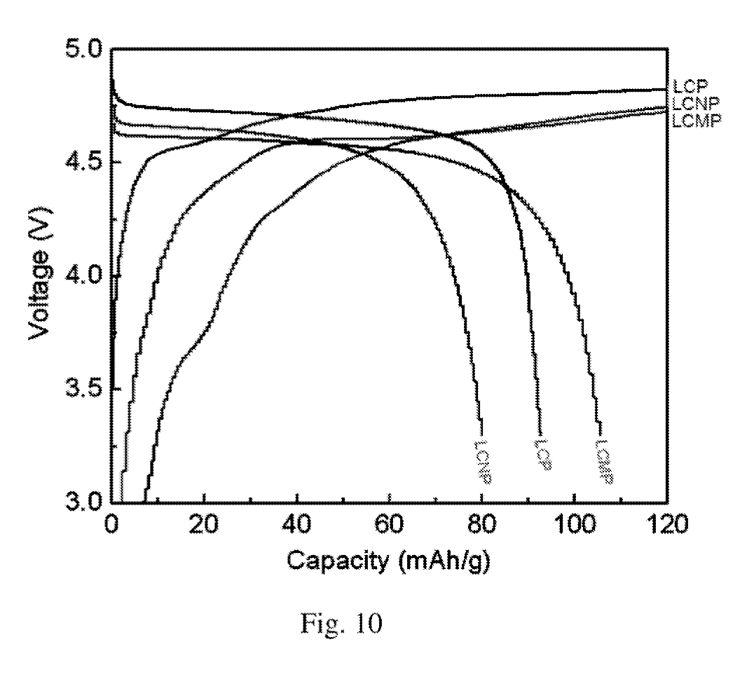

FIG. 10 shows the SEM images of one embodiment of LCP/C nanocomposite particles prepared using the one-step procedure with different processing, here 8 hours in this embodiment. As shown in FIG. 6, the typical size of these particles synthesized was ˜50-80 nm, as shown in FIG. 6. In addition, the particles had two typical shapes: (1) sphere shapes and (2) rectangular-plate shapes (thickness ˜60 nm). These particles aggregated together in the course of synthesis, forming larger-size particles that are typically with the dimension of 1-3 micrometers.

### Electrochemical Testing and Prototyping

Electrochemical testing results, including charging-discharging and cycle performance tests, may be used to illustrate features of certain embodiments. The tests may be conducted by testing coin cells fabricated using cathode materials.

The charge-discharge characteristics of the prepared cathode materials may be examined using a coin cell (2032 type).

In a certain embodiment, Cathodes fabrication is carried out started with the fluxing 70-80 wt. % of the corresponding active material, 10-20 wt. % acetylene black (AB) as a conductor, and 10 wt. % polyvinylidene dichloride (PVDF) as a binder. The mixture slurry is then coated on an Al foil and dried in a vacuum furnace at 120° C. overnight and the coated foil is then punched into a circular disk. The resultant cathode is ˜50 um thick and contained approximately 2-3 mg/cm² of active material. The cell consisted of a cathode, electrolyte, a lithium metal anode, and a Celgard 3501 separator. The electrolyte is a 1M LiPF₆-ethylene carbonate/dimethyl carbonate (EC/DMC) solution. Galvanostatic charge-discharge experiments are be performed at a voltage range of 3.3 volts to 4.95 volts for LCP-based materials and 2.5 volts to 4.2 volts for LFP-based materials. The experiments are conducted using a MTI 8-channel battery analyzer.

LCP/C Nanocomposite with Three-Step Procedure

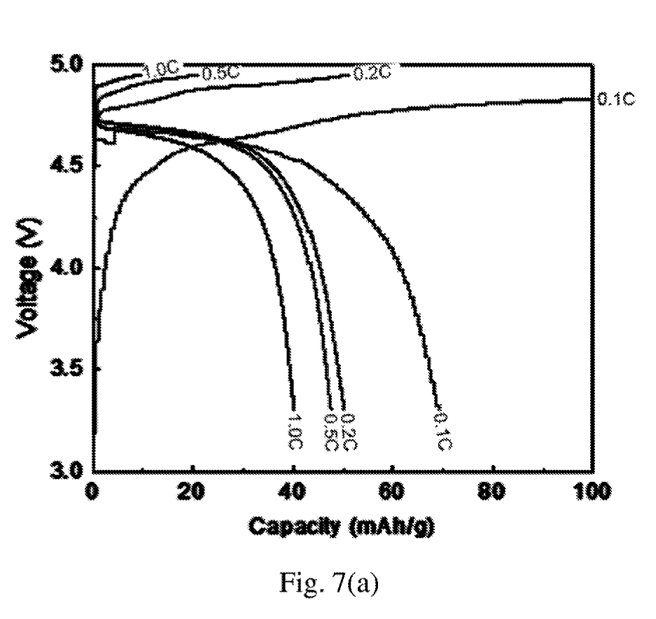

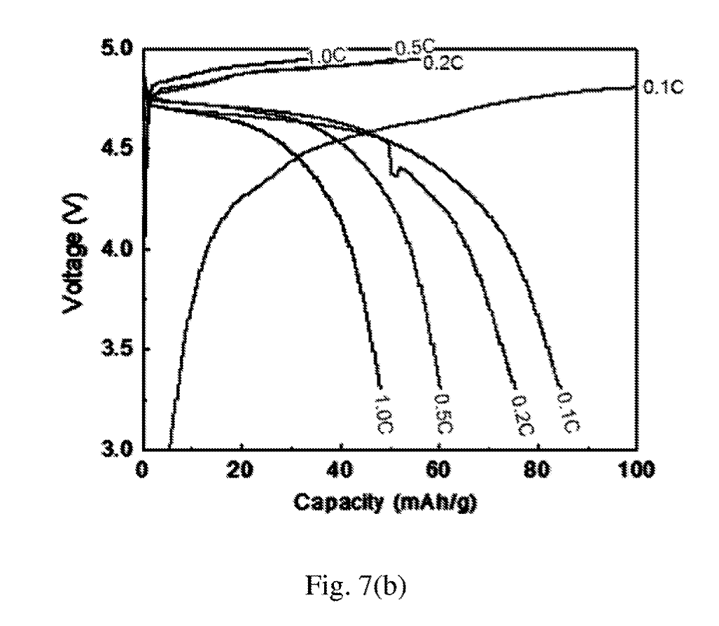

FIG. 7(a) shows the charge-discharge curves of an embodiment of LCP/C nanocomposite that is synthesized with the three-step procedure consisting of (1) solid-state reaction; (2) cryomilling; and (3) carbon coating. In FIG. 7(a), the electrochemical performance is not as good as that of LCP fresh powder, although a much reduced average particle size (from ·2.5 μm to submicron) and carbon-coating are achieved. The possible reasons might be due to the change in crystalline structure of the LCP and the generation ref microcracking and aggregation of the particles during cryomilling. A similar annealing process as that of a cryomilled fresh powder sample is conducted for the LCP/C nanocomposite in order to resume the crystalline microstructure. The charge-discharge curves of resultant sample are shown in FIG. 7(b). It is clear that the capacity of the LCP/C nanocomposite is enhanced substantially (˜20%) after annealing.

LCP/C Nanocomposite Synthesized with One-Step Procedure

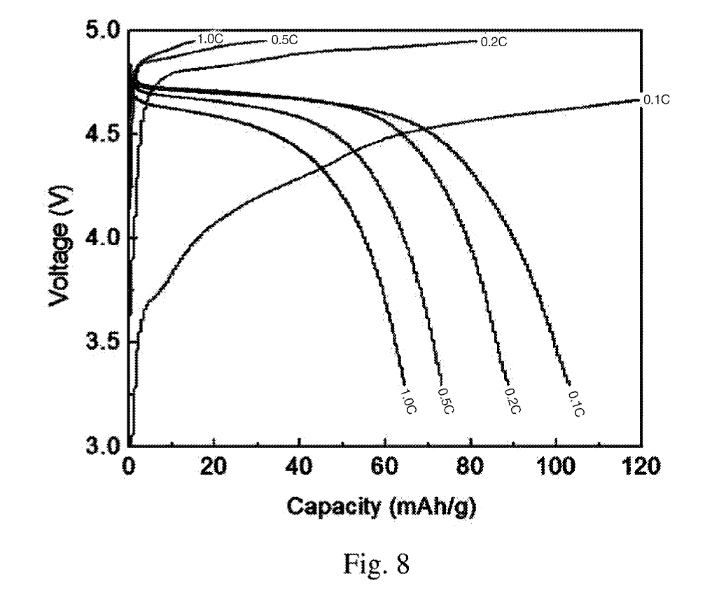

FIG. 8 shows the charge-discharge curves of an embodiment of LCP/C nanocomposite prepared with the one-step procedure. When sintering time is 18 hours, the capacity is improved to up to ˜105 (mAh/g), showing considerable improvement as compared with LCP fresh powders.

### Alternative Embodiments

Many alterations and modifications may be made by those having ordinary skill in the art without departing from the spirit and scope of the invention.

For example, (1) substitute-doped LiCoPO4 (2) substitute-doped LiFePO4; (3) substitute-doped LiMCoPO4/C (M=Mn, or Fe) nanocomposites.

In one embodiment with LiCoPO4 and LiFePO4 cathode materials, the materials are prepared with 10% substitution of Mn and Ni elements for M in LiMPO4 (M=Fe, Co). The prepared samples included (1) LiCo_{0.9}Mn_{0.1}PO₄, (2) LiCo_{0.9}Ni_{0.1}PO₄, (3) LiFe_{0.9}Mn_{0.1}PO₄, and (4) LiFe_{0.9}Ni_{0.1}PO₄. The substitutions of other kind of M elements for the host atom in LiMPO4 facilitate a wider channel for Li diffusion that will enhance the mobility of Li ions.

In an embodiment, LCP samples doped with 10 mol. % Mn and Ni elements, respectively, are synthesized. The starting materials shown in Table 4 were mixed with high energy ball milling for 4 hours using a planetary milling machine. The materials are then tired in a tube furnace under an argon atmosphere.

TABLE 4
SSR synthesis of doped LCP powder

| Sample | | | Synthesis |
|---|---|---|---|
| Name | Target Material | Starting Material | Parameters |
| LCMP | 10% Mn-doped LCP | Li₂CO₃; CoO; | 650° C., |
| | | P₂O₅; Mn₂O₃ | 36 h |
| LCNP | 10% Ni-doped LCP | Li₂CO₃; CoO; | 650° C., |
| | | P₂O₅; NiO | 36 h |

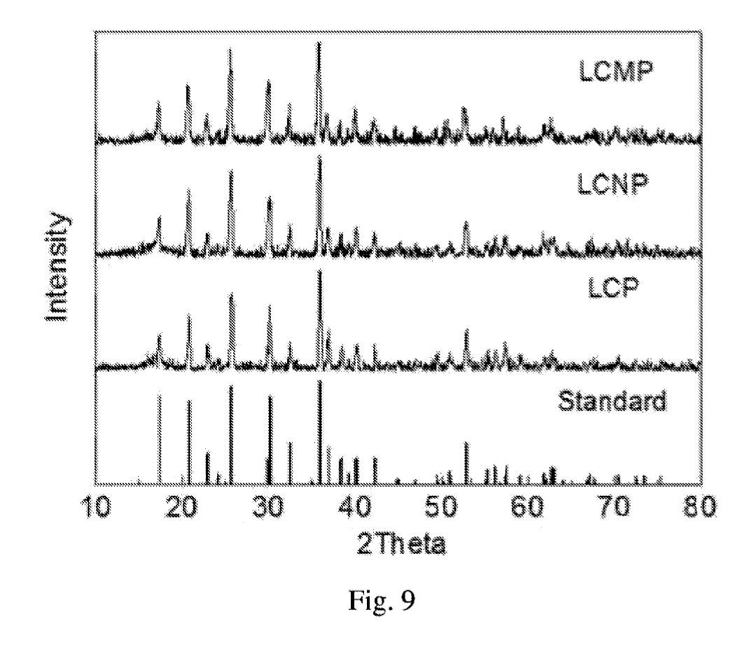

The following FIG. 9 shows the XRD results of an embodiment with LCP samples doped with 10 mol. % Mn and Ni elements, respectively. Compared to the standard pattern and un-doped LCP sample, it was found that there was no observable difference in XRD patterns of doped samples, suggesting the crystal structure is well maintained with the doping of substitute elements of Mn and Ni for Co.

FIG. 10 illustrates the preliminary electrochemical tests in charging-discharging performance of an embodiment of LCP samples doped with 10 mol % Mn and Ni elements, respectively. FIG. 10 only shows first charge-discharge cycles at 0.1 C are showed. As a comparison, LCP fresh powder are also listed. As observable from FIG. 10, (1) substitute doping of Mn element in LCP demonstrates ˜10% improvement as compared with LCP fresh powders (105 mAh/g of LCMP vs. 95 mAh/g of LCP); (2) substitute doping of Ni element in LCP does not exhibit capacity enhancement even with some capacity decrease (˜80 mAh/g of LCNP vs. 95 mAh/g of LCP). Therefore, LCP performance may be improved thru doping Mn elements in LCP.

### Substitute-Doped LFP

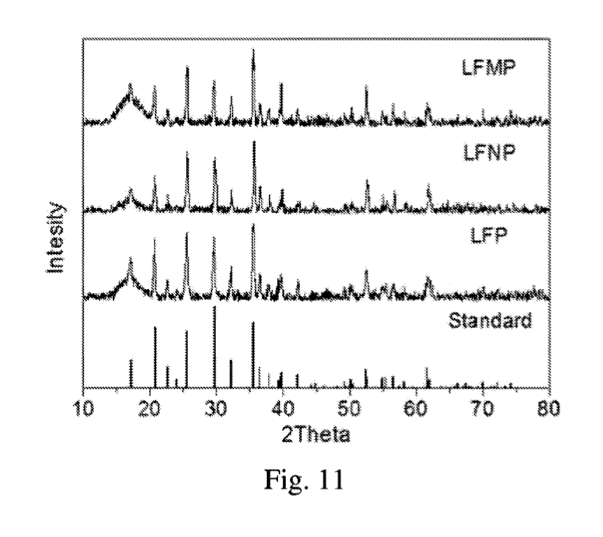

Another embodiment is where LFP samples are doped with 10 mol. % Mn and Ni elements, respectively. Table 5 shows the starting materials for LFP and its doped samples with Mn and Ni. FIG. 11 shows the XRD results of LFP pure and doped samples with 10 mol. % Mn and Ni elements, respectively.

TABLE 5
SSR synthesis of doped LCP powder

| Sample | | | Synthesis |
|---|---|---|---|
| name | Target material | Starting material | parameters |
| LFP | Pure LFP | LiOH; Fe₂O₃; | 700° C., |
| | | (NH₄)₂HPO₄; C | 12 hrs |
| LFMP | 10% Mn-doped LFP | LiOH; Fe₂O₃; C; | |
| | | (NH₄)₂HPO₄; Mn₂O₃ | |
| LFNP | 10% Ni-doped LFP | LiOH; Fe₂O₃; C; | |
| | | (NH₄)₂HPO₄; NiO | |

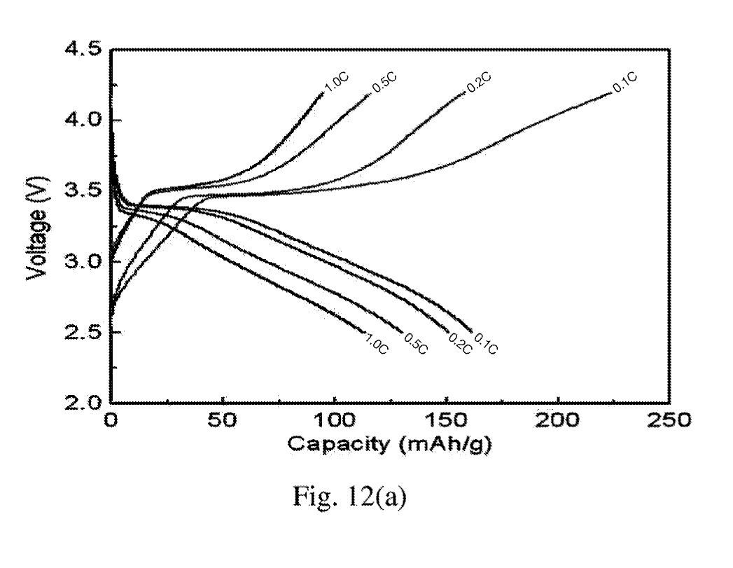

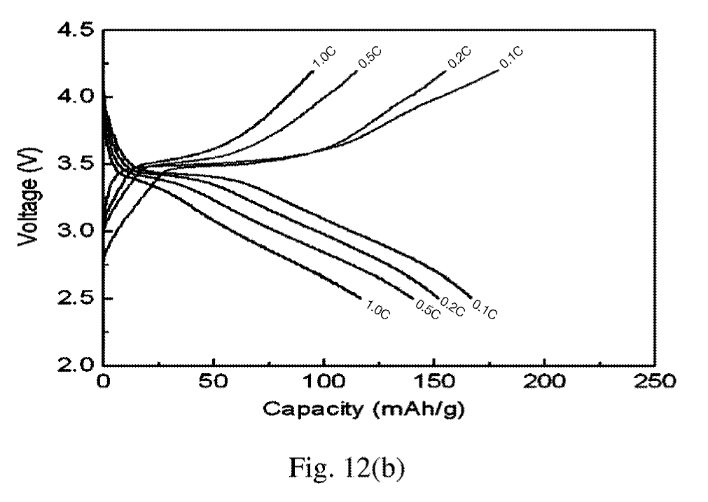

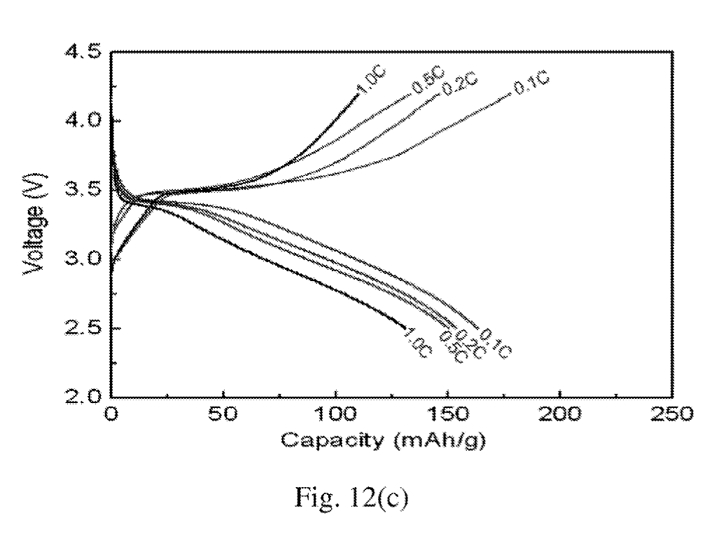

FIG. 12(a), FIG. 12(b) and FIG. 12(c) shows the charge-discharge results of embodiments of pure and doped LFP. Features of this embodiment include (1) Very high specific capacity, close to the theoretical value of LFP (167 mAh/g for LFMP, and 163 mAh/g for LFNP), is achieved for two doped samples (The base material of LFP also demonstrates a capacity of 167 mAh/g); (2) Compared with pure LFP without any doping, LFMP (LiFe_{0.9}Mn_{0.3}PO₄) exhibits a larger capacity improvement than LFNP at low current rating of 0.1 C (˜4% vs. ˜1%); However, at high current rating (e.g., especially at 1 C), improvement of LFNP is obviously larger the LFMP (˜17% vs. ˜3%); (3) Mn Ni elements are effective dopants in pure LFP due to the resultant charge-discharge plateaus.

### Substitute-Doped LiMCoPO4/C (M=Mn, Fe, Ni) Nanocomposite

Other embodiments include an Mn-doped LiCoPO4/C nanocomposite. In this embodiment, a novel cathode material, Mn-doped LiCoPO4/C nanocomposite, can be cost-effectively processed with a single-step processing similar with a solid-state reaction, in which all the raw materials including carbon source and dispersant are first mixed with the aid of high energy ball milling. The utilization of high energy ball milling will not only lead to a homogenous mixing, small (e.g. nano-size), but also bring about the effect of mechanical alloying through which a “composite” particle having the same composition as that desired can be formed. The high energy ball milling is also referred to as mechanical alloying.

With this embodiment of a new material design, three contribution factors for performance improvement of cathode materials, including substitute-doping, nano-sized particle and carbon-coating, can be combined together and accomplished in as single processing step. This approach is expected to lead to a more efficient, easily scalable procedure to fabricate the high performance cathode materials at a low cost. This material approach for this embodiment of Mn-doped LiCoPO4/C nanocomposite should be applicable for the other doping elements (e.g. Fe, Ni).

### How the Invention is Used

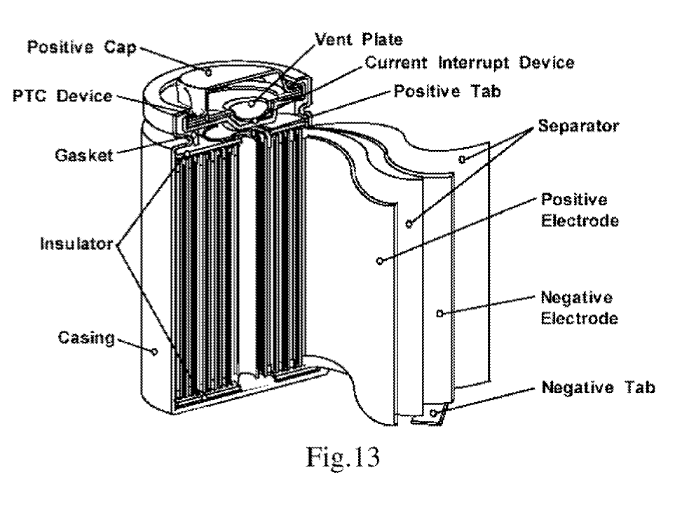

Among the many uses for an electrode material is for use in a battery. In usage with an embodiment, the electrode materials may be an LCP/C nanocomposite of a one-step procedure. For example, a cathode material may be used for a 18650 cylindrical cell battery. FIG. 13 illustrates a typical structure of such a battery.

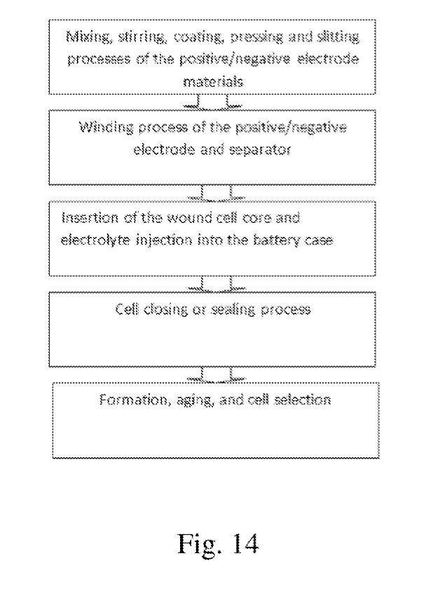

A flow-chart for the general assembly procedure for such a cell is shown FIG. 14.

### Advantages

The described versions of the present invention have many advantages, including having high energy density while being cost-effective, environmentally benign and able to be charged and discharged at high rates for a large number of cycles over a period of many years.

For example, some of the advantages of using high-voltage, nanoparticle-sized active materials in the positive electrode for Li-ion batteries include: (1) a much shorter Li-ion diffusion length (through the lattice) from the center of the particle to the particle surface. This means that particle dimensions in the nanometer-range lead to shorter lithium diffusion lengths, which can provide a higher capacity. (2) Nanomaterials can feature a large specific surface area such that higher charge/discharge rates can be facilitated. (3) Particle cracking, leading to pulverization and corresponding capacity loss, can be prevented if the particles are small enough.

As an example of an advantage, for ˜1 μm-sized coarse particle, Li-ion diffusion length in the lattice of grain is around 0.5 μm and specific surface area is small, while for ˜100 nm-sized fine particle, a length is around 50 nm (10 times shorter) and the total surface area may be even much larger (in the magnitude of 100 times). Therefore a more efficient Li-ion diffusion would result with substantially enhanced electrochemical performance.

Furthermore, the invention does not require that all the advantageous features and all the advantages need to be incorporated into every embodiment of the invention. Also, this partial list of advantages is not an exhaustive list or description of all of the advantages from the embodiments and versions of the present invention.

### Closing

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

Where reference is made herein to a method comprising two or more defined steps, the defined steps can be carried out in any order or simultaneously (except were the context excludes that possibility), and the method can include one or more other steps which are carried out before any of the defined steps, between two of the defined steps, or after all the defined steps (except where the context excludes that possibility).

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Thus, specific embodiments and applications of the present invention have been disclosed. It should be apparent, however, to those skilled in the art that man more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A method of creating a battery material comprising the steps of:
a) high energy ball milling starting material particles to create complex particles; and
b) sintering said complex particles to create a carbon coated nanocomposite.

2. The method of claim 1 wherein said high energy ball milling dopes and composites said starting material particles to create said complex particles.

3. The method of claim 2 wherein said starting materials particles are comprised of Li, Co, PO₄, C and at least one metal.

4. The method of claim 3 wherein said metal is selected from the group consisting of Fe, Mn, and Ni.

5. The method of claim 4 wherein said metal is Mn.

6. The method of claim 5 wherein said nanocomposite is LiCoMnPO₄/C wherein C is a carbon coating.

7. The method of claim 1 wherein said coated carbon comprises a coating that consists essentially of carbon.

8. The method of claim 3 wherein said starting materials comprise Li₂Co₃, CoO, P₂O₅ and a metal oxide.

9. The method of claim wherein said carbon coated nanocomposite comprises coated LiCoₓM_{y}PO₄, where M is a metal selected from the group consisting of Fe, Mn, and Ni and the sum of x and y equals 1.

10. The method of claim 1 wherein said coated nanocomposite comprises a coated doped nanocomposite.

11. A method of preparing a coated carbon nanocomposite that comprises the steps of:
a) subjecting starting materials comprising sources of lithium, cobalt and phosphorous to solid state reaction to form a pure phase powder;
b) cryomilling said pure phase powder to yield nano-sized particles; and
c) coating said nano-sized particles with a carbon coating.

12. The method of claim 11 wherein step a comprises using staring materials that contain a source of metal that is selected from the group consisting of Fe, Mn, and Ni.

13. The method of claim 11 wherein step c comprises mixing said nano-sized particles with a source of carbon to form a mixture that is heated in an inert atmosphere.

14. The method of claim 13 wherein said source of carbon comprises a polymer solution and wherein said mixture is milled and dried before being heated.

15. The method of claim 11 wherein said carbon coating comprises a coating that consists essentially of carbon.

16. The method of claim 11 wherein step c forms carbon coated nanocomposite that comprises coated LiCoₓM_{y}PO₄, where M is a metal selected from the group consisting of Fe, Mn, and Ni and the sum of x and y equal 1.

17. The method of claim 11 wherein said coated nanocomposite comprises a coated doped nanocomposite.

18. A method of preparing a coated carbon nanocomposite that comprises the steps of:
a) combining starting materials comprising sources of lithium, cobalt and phosphorous and a source of carbon to form a form a mixture; and
b) subjecting the mixture of solid sate reaction to form the nanocomposite.

19. The method of claim 18 wherein in step a, said starting materials and source of carbon are balled milled before being subjected to solid state reaction.

20. The method of claim 8 wherein step b comprises heating the mixture in an inert gaseous environment.

21. The method of claim 18 wherein step b forms a coated carbon nanocomposite having a coating that consists essentially of carbon.

22. The method of claim 18 wherein step b forms a carbon coated nanocomposite that comprises coated LiCoₓM_{y}PO₄, where M is a metal selected from the group consisting of Fe, Mn, and Ni and the sum of x and y equals 1.

23. The method of claim 18 wherein said coated nanocomposite comprises a coated doped nanocomposite.
